(19) United States
(12) Patent Application Publication
(10) Pub. No.: US 2014/0027253 A1
(43) Pub. Date: Jan. 30, 2014

(54) ELECTRIC MACHINE-TOOL COMPRISING A LOCKABLE ROCKER SWITCH

(71) Applicant: Willy Braun, Neustetten (DE)

(72) Inventor: Willy Braun, Neustetten (DE)

(73) Assignee: Robert Bosch GmbH, Stuttgart (DE)

(21) Appl. No.: 13/810,904

(22) PCT Filed: Jun. 3, 2011
(86) PCT No.: PCT/EP11/59183

§ 371 Date: Apr. 4, 2013

(30) Foreign Application Priority Data
Aug. 2, 2010 (DE) 10 2010 038 750.9

(51) Int. Cl. H01H 9/22

(52) U.S. Cl. CPC H01H 9/226
USPC 200/61.58 R

(57) ABSTRACT

An electric machine-tool includes an anti-vibration handle casing. A mechanical actuating device and a locking device configured to lock the mechanical actuating device in at least one operating state of the electric machine-tool are arranged in the handle casing. The electric machine-tool also includes an electric switch configured to be moved by the mechanical actuating device into a switched-on and a switched-off position. The handle housing comprises a handle area extending along a longitudinal extension of the mechanical actuating device. The electric switch is arranged outside of the handle area.

### PRIOR ART

The present invention relates to an electric machine tool, in particular a hammer drill, comprising a handle casing, particularly an antivibration handle casing, in which a mechanical actuating device and a locking device for locking the mechanical actuating device in at least one operating state of the electric machine tool are disposed, and further comprising an electric switch, with which the electric machine tool can be switched on and off.

For electric machine tools, in particular for drills and/or chipping hammers, it is known to damp the vibrations in the handle through the use of an elastic element between the handle and the tool housing of the electric machine tool. Such handles are also referred to as antivibration handles. The elastic element allows the handle to be moved relative to the tool housing in the horizontal and/or vertical direction. An electric machine tool comprising an elastic element of this kind is shown by printed publication WO 2008/000543 A1.

In order to enable easy operation of an electric machine tool, it is further known to dispose in the handle an electric switch, with which the electric machine tool can be switched on and off.

In hammer drills, in order to enhance user comfort, such a switch disposed in the handle is frequently lockable in “chipping operation” in order that the operator does not have to keep the switch in this operating mode constantly pressed. However, the switch must not be able to be locked in “drilling” or “hammer drilling operation”, in order that the electric machine tool can be switched off by the user as quickly as possible should the drill tilt and does not twist uncontrollably, and that the operator does not get injured.

Printed publication DE 10 2008 041 511 A1 shows a portable power tool comprising such a switch disposed in the handle, which switch comprises an electric switch and a rocker switch which is disposed on the electric switch and with which the electric switch can be actuated. The rocker switch can be locked in an operating state of the power tool by means of a locking device.

However, the locking function in antivibration handles can be realized only with great difficulty, since an operating mode switch is traditionally disposed on the tool housing and a relative movement of several millimeters can occur between the handle casing and the tool housing. Moreover, such an on and off switch calls for considerable installation space, which is all the larger the more powerful the electric machine tool.

### DISCLOSURE OF THE INVENTION

The object of the present invention is to provide an electric machine tool comprising a handle, in particular an antivibration handle, in which a switching element which is lockable at least in one operating state of the machine is disposed, wherein the handle is very compactly and stably built.

The object is achieved with an electric machine tool, in particular a hammer drill, comprising a handle casing, particularly an antivibration handle casing, having a mechanical actuating device, a locking device and an electric switch, wherein the mechanical actuating device can be locked by means of the locking device in at least one operating state of the electric machine tool, wherein the electric switch is adjustable by means of the mechanical actuating device into a switched-on and into a switched-off position, wherein the handle casing has a grip region extending along a longitudinal extent of the mechanical actuating device, and wherein the electric switch is disposed outside of the grip region.

Since the electric switch is disposed outside of the grip region, the handle casing can be built very compactly in the grip region, to be precise irrespective of the power of the portable electric machine tool. The placement of the electric switch outside of the grip region enables a reduction in the size of the handle in the grip region and therefore an improvement in the ergonomics of the handle. All in all, the electric machine tool is thereby easier to handle.

Preferably, the handle casing is additionally reinforced, at least in the grip region, by reinforcing means, for instance reinforcing ribs and/or wall thickenings. The handle casing can hence be built, in comparison to a traditional handle casing of the same generic type, more stably and, despite the reinforcing means, in smaller dimension, since the installation space which is traditionally used for the electric switch is available in the inventive handle as an unused installation space.

In a preferred embodiment, the electric switch extends along a switch longitudinal extent, which is provided at an angle, in particular at a right angle or parallel, to the longitudinal extent of the actuating device. Since the electric switch, according to the invention, is not provided in the grip region, the handle casing, despite the switch longitudinal extent provided at the angle to the longitudinal extent of the actuating device, can be built ergonomically. In principle, the electric switch can be placed in any chosen, little used installation space of the electric machine tool, to be precise at any chosen angle to the longitudinal extent of the actuating device.

In a preferred embodiment, the electric machine tool has a tool housing on which the handle casing is disposed, in particular such that it is movable relative thereto, and in which the electric switch is disposed. The electric switch is hence exposed to no direct shock load should the electric machine tool fall over. However, an embodiment in which the electric switch is disposed partially or fully in the handle casing, but outside of the grip region, is likewise preferred.

The locking device is preferably disposed within the grip region. Particularly preferably, it is disposed at least partially within the mechanical actuating device, so that the distance between the locking device and the mechanical actuating device, which is to be bridged for the locking of the mechanical actuating device, is as small as possible. Both the mechanical actuating device and the locking device are here mounted rotatably, particularly preferably independently from each other, on the handle casing. The mechanical actuating device and the locking device are hence adjustable independently from each other.

Also preferably, the locking device is connected by means of an at least partially flexibly designed first connecting means to an operating mode switch of the electric machine tool. Moreover, it is preferred that also the mechanical actuating device is connected by means of an at least partially flexibly designed second connecting means, in particular comprising a band, a Bowden cable or a resiliently attached lever, to the electric switch. The at least partially flexibly designed first or second connecting means respectively enables a connection via curved paths. In addition, as a result of the at least partially flexibly designed first and/or second connecting means, no appreciable vibrations are transmitted from the tool housing into the handle casing.

The first connecting means and/or second connecting means can either be capable of withstanding only tensile load, in particular a band, wire or stamped bent part, or of withstanding both tensile and compressive load, in particular a Bowden cable or lever.

The second connecting means, realized as a lever, is preferably configured as a push rod. Particularly preferably, this is connected by means of a resilient film hinge to the mechanical actuating device, quite especially preferably integrally.

The operating mode switch is preferably disposed in the tool housing and also preferably comprises at least one cam, with which a slide bar, to which the first connecting means is fixed, is displaceable. Preferably, the slide bar, for the adjustment of the operating modes, is adjustable in a sliding direction.

In a preferred embodiment, the mechanical actuating device is a rocker switch, which is rotatably mounted on the handle casing. The rocker switch here preferably has a first rocker switch part and a second rocker switch part, wherein it also preferably is adjustable by actuation of the first rocker switch part into a switch-on position, and by actuation of the second rocker switch part into a switch-off position. It is here preferred that the electric switch, in the switch-on position of the rocker switch, is in the switched-on position, while, in the switch-off position of the rocker switch, it is preferably in the switched-off position.

The electric machine tool of this embodiment is, for instance, a hammer drill, wherein a “drilling operation”, a “chipping operation” and a combined “hammer drilling operation” are preferably provided as the operating modes. The locking device of this embodiment locks the rocker switch preferably in the “chipping operation” of the hammer drill, to be precise in the switch-on position. However, embodiments in which the locking device locks an electric machine tool in another operating mode are also preferred. In this case, it is likewise preferred that electric switches are here in a position other than the switch-on position.

On the second connecting means is preferably disposed a transforming means. In a preferred embodiment, the transforming means enables a reduction of the force which is to be applied by the user for the adjustment of the electric switch, so that the operation of the mechanical actuating device is very easy. Preferably, the transforming means additionally or alternatively enables a nonlinear course of the adjustment path to the adjusting force to be applied, for instance a degressive course. A degressive course means that the force to be applied by the operator, in the pressing of the mechanical actuating device, is all the smaller the further the mechanical actuating device is pressed.

A transforming means is preferably a cable pulley, which is provided between the electric switch and the second connecting means. Likewise preferably, a lever gear mechanism is provided as transforming means between the electric switch and the second connecting means. Both the cable pulley and the lever gear mechanism enable the reduction of the force to be applied by the operator for the adjustment of the electric switch. The lever gear mechanism additionally enables the realization of the nonlinear adjusting force to adjustment path courses, so that ergonomically favorable actuation courses for the mechanical actuating device can be realized.

The object is further achieved with a handle casing for an inventive electric machine tool. The handle casing of the inventive electric machine tool is configured such that it has a grip region, in which a mechanical actuating device, in particular a rocker switch, extends along its longitudinal extent, wherein no electric switch actuated by means of the mechanical actuating device is disposed in the grip region. The handle casing is in the grip region preferably reinforced by reinforcing means, for instance reinforcing ribs and/or wall thickenings, and is also preferably configured very ergonomically.

The object is further achieved with a locking device for an inventive electric machine tool. The locking device preferably has a pivot means rotatable about a locking pivot point. It also has a latching means. The object is further achieved with a mechanical actuating device, in particular a rocker switch, for an inventive electric machine tool. The mechanical actuating device has a counterlatching means, in particular a locking roller.

In a first preferred embodiment, the latching means of the locking device is of resilient design, so that it can roll along the counterlatching means of the mechanical actuating device, wherein it is adjusted in the vertical and/or horizontal direction. Basically, a, where necessary, additional lateral adjustment is also preferred. In this embodiment, the latching means is preferably mounted such that it is displaceable and/or twistable against the force of a spring. It is also preferred that, when the mechanical actuating device is locked by means of the locking device, the position of the counterlatching means in the handle casing does not change.

In a second preferred embodiment, the counterlatching means of the mechanical actuating device is of resilient design, so that it can roll along the latching means of the locking device, wherein it is adjusted in the vertical and/or horizontal direction. Basically, a, where necessary, additional lateral adjustment is also preferred. In this embodiment, the latching means is preferably mounted such that it is displaceable and/or twistable against the force of a spring. It is also preferred that, when the mechanical actuating device is locked by means of the locking device, the position of the latching means in the handle casing does not change.

Preferably, the latching means of the locking device and the counterlatching means of the mechanical actuating device, in a locking position of the locking device, cooperate such that the mechanical actuating device is latch-locked at the locking device. Further preferably, the latched mechanical actuating device is in its switch-on position.

The object is further achieved with a connecting means for an, in particular, inventive electric machine tool, which connecting means, at least in part, is flexibly configured and, for the connection of a sliding means to a mechanical actuating device, is connected by its first end to the sliding means and by its second end to the mechanical actuating device, so that the sliding means is adjustable by the length of a slide path in that the mechanical actuating device is adjusted with an adjusting force by the length of an adjustment path, wherein the connecting means comprises a transforming means, with which the adjusting force which is to be applied for the adjustment of the sliding means by the length of the slide path on the mechanical actuating device is variable along the adjustment path, and/or can be reduced. Variable in this sense is a nonlinear, in particular degressive, course of the adjusting force over the adjustment path. The transforming means enables ergonomically favorable actuation courses for the mechanical actuating device.

The invention is described below with reference to the figures. The figures are merely illustrative and do not restrict the general inventive concept.

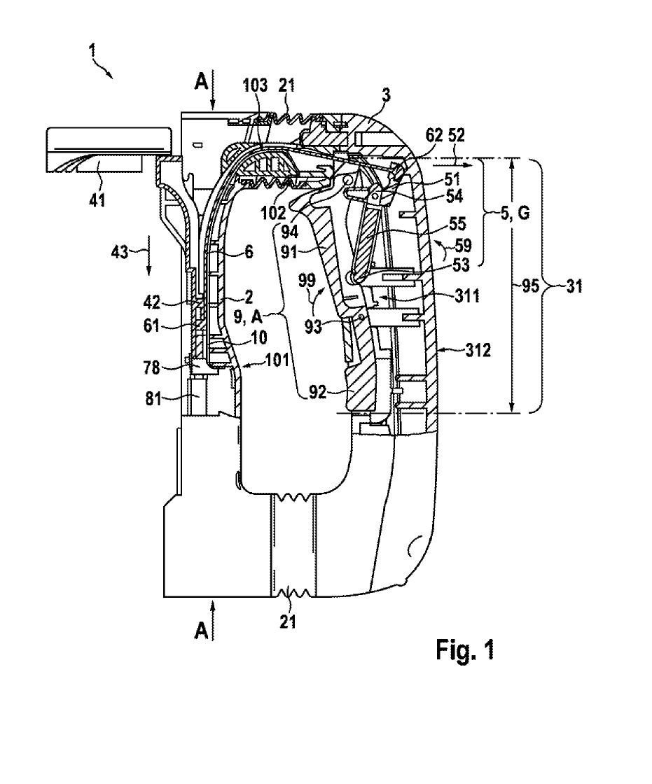

FIG. 1 shows a detail from an inventive electric machine tool comprising an antivibration handle casing, in which a mechanical actuating device lockable by means of a locking device is disposed,

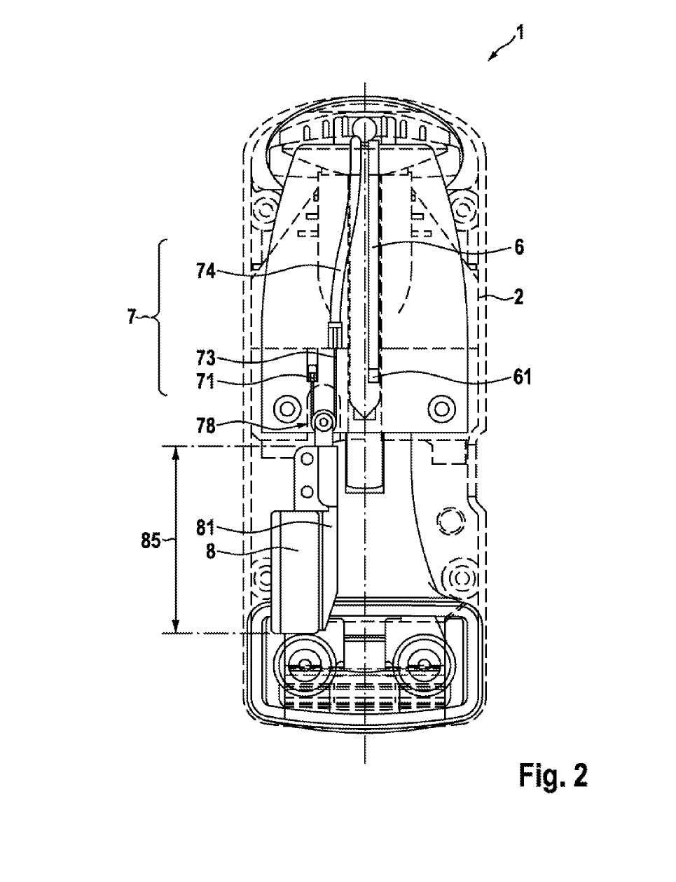

FIG. 2 shows a section A-A through the electric machine tool of FIG. 1,

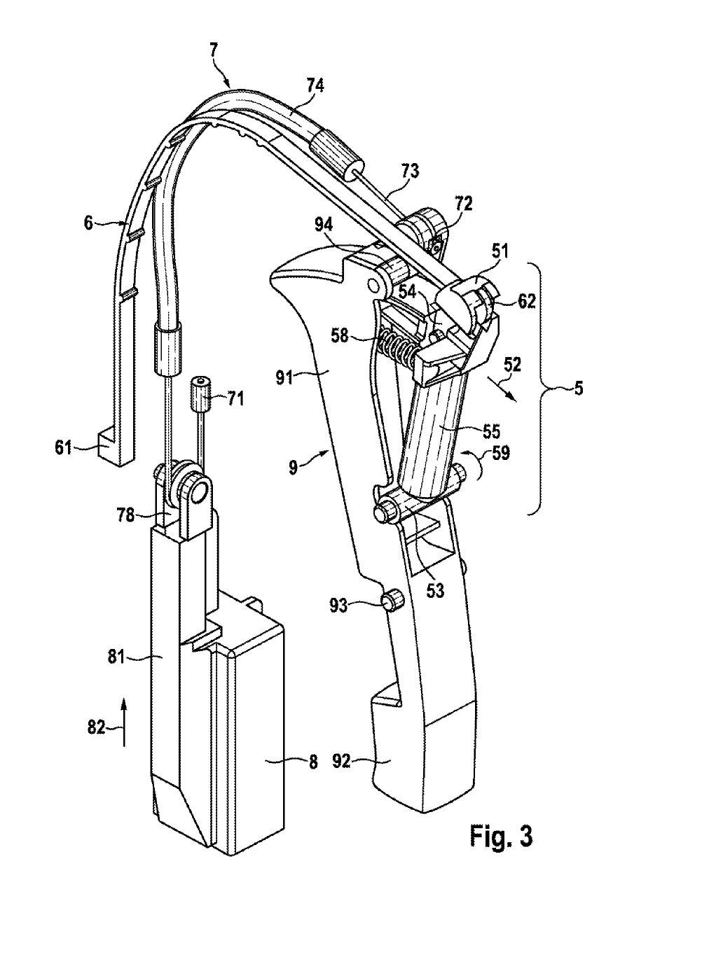

FIG. 3 shows the mechanical actuating device, the locking means, the electric switch, and the first and second connecting means of the electric machine tool of FIG. 1,

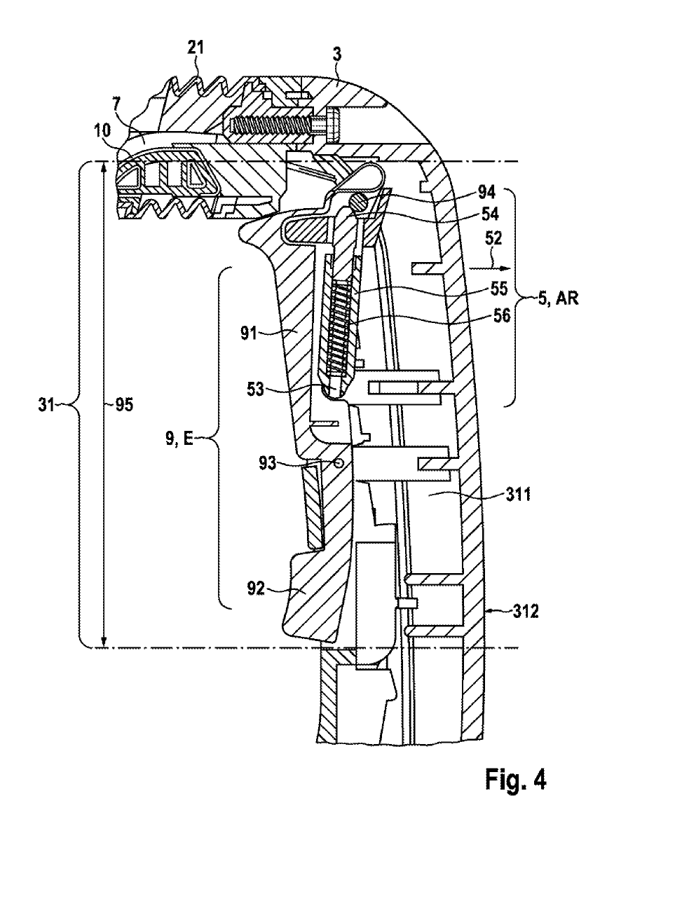

FIG. 4 shows a detail from a further embodiment of an inventive electric machine tool,

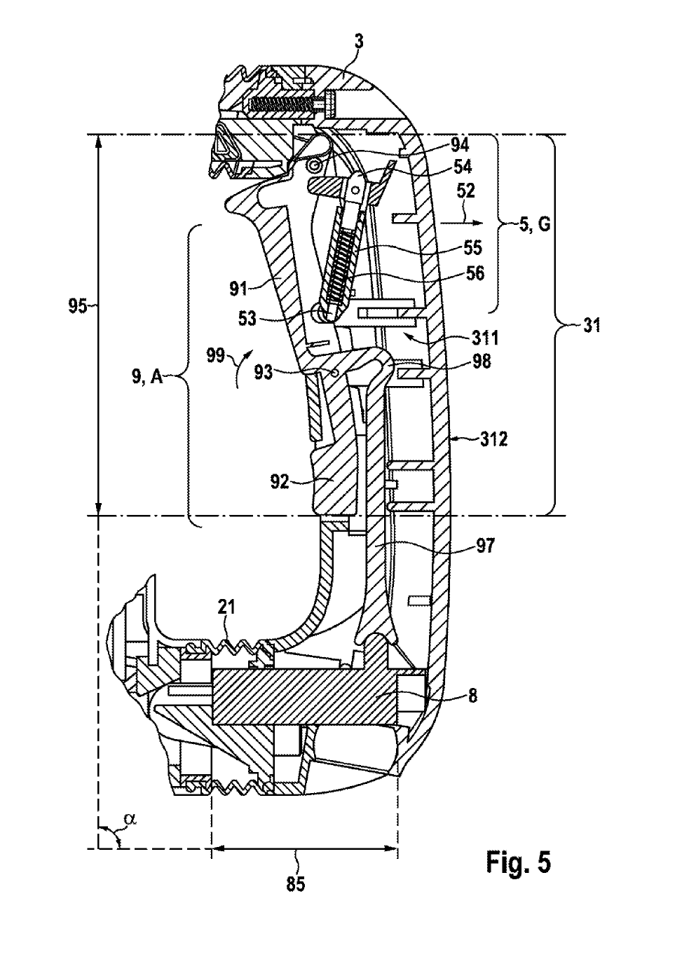

FIG. 5 shows the electric machine tool of FIG. 1 with a section through the locking device,

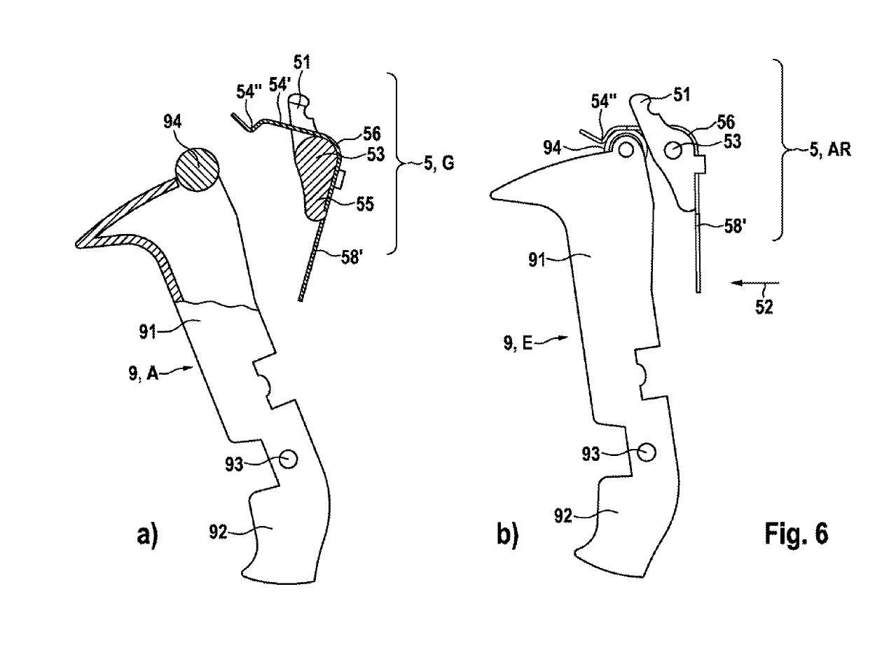

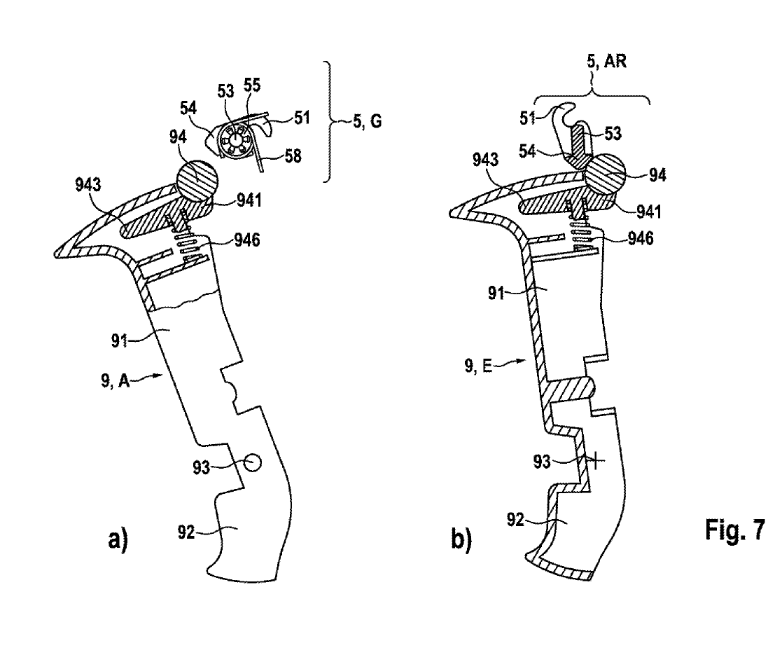

FIGS. 6 and 7 respectively show a mechanical actuating device and a locking device for an inventive electric machine tool, to be precise respectively in (a) in a switch-off position and in (b) in a switch-on position of the mechanical actuating device, and

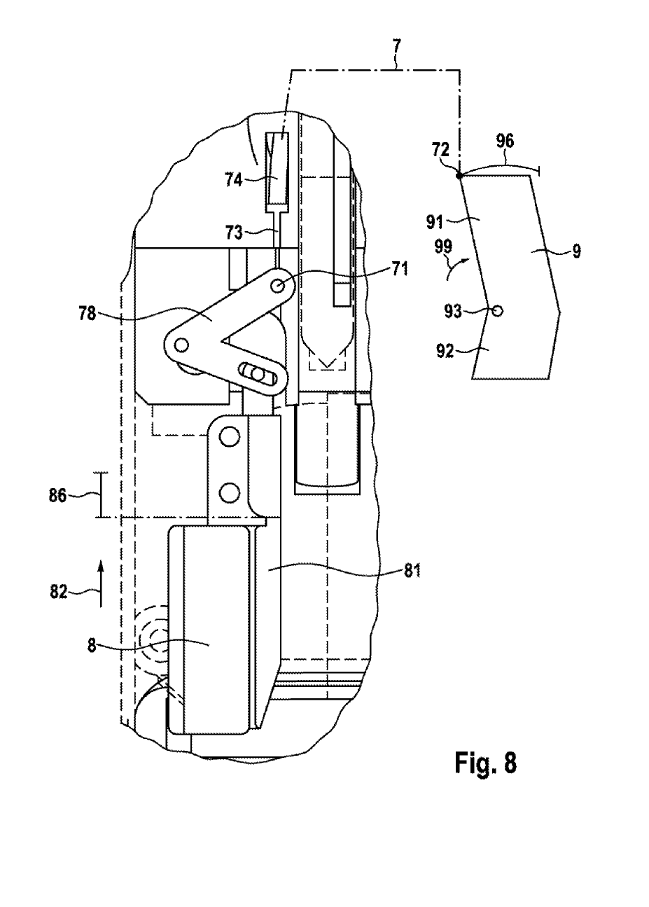

FIG. 8 shows a detail from a further embodiment of an inventive electric machine tool.

FIG. 1 shows a detail from an inventive electric machine tool 1 comprising a handle casing 3, configured as an antivibration handle casing, in which a mechanical actuating device 9, lockable by means of a locking device 5, is disposed.

The handle casing 3 is supported on a tool housing 2 by means of an elastic connecting means 10, here a leaf spring. Below, the terms elastic connecting means 10 and leaf spring are used synonymously. The leaf spring here has a first end 101 and a second end 102, wherein it is connected by its first end 101 fixedly to the tool housing 2. The handle casing 3 is supported at the second end 102 of the leaf spring 10 on the top side 103 thereof, so that it can compress both in the horizontal and in the vertical direction. A relative movement of several millimeters between the tool housing 2 and the handle casing 3 is thereby possible.

Between the tool housing 2 and the handle casing 3 are provided two bellows elements 21, which allow the relative movement between the tool housing 2 and the handle casing 3 such that neither the tool housing 2 nor the handle casing 3 are damaged by the relative movement.

The electric machine tool 1 of this illustrative embodiment is a hammer drill, which is adjustable by means of an operating mode switch 41 into the “drilling”, “hammer drilling” and “chipping” operating modes. The operating mode switch is configured, for instance, as a rotary knob or as a slide bar. For the adjustment of the operating modes, the operating mode switch 41 comprises an actuating means, for instance a cam contour (not visible), which displaces a slide bar 42 in the adjustment from one operating mode into the other operating mode in or counter to a direction of displacement 43.

To the slide bar 42 is fixed a first end 61 of the first connecting means 6. The first end 61 of the first connecting means 6 can be hooked onto the slide bar 42, for instance under the preload of a spring (not represented), or can be fixedly connected to the slide bar 42 by screwing or clipping in.

A second end 62 of the first connecting means 6 is fixed to a tilt lever part 51 of the locking device 5.

To be precise, the second end 62 is here hooked in the tilt lever part 51, which is of hook-shaped configuration. It is also preferred, however, to fixedly connect the second end 62 to the locking device 5. Also preferred is an embodiment in which the locking device 5 comprises, instead of the tilt lever part 51, a sliding part (not represented), to which the second end 62 of the switching connector 6 is fixed.

The locking device 5 comprises a pivot means 55, which is mounted on the handle casing 3 rotatably about a locking pivot point 53. Through rotation of the locking device 5 in the locking rotational direction (here shown by an arrow 59), the pivot means 55 is adjustable against a resetting force (here shown by an arrow 52), which is generated by a restoring spring 58 (see FIG. 3), from a basic position G into a locking position AR. Through back-rotation counter to the locking rotational direction 59 and in the direction of the resetting force, it can be reset from the locking position AR into the basic position G. In addition, the locking device 5 comprises a spring means 56 (see FIG. 4) and a latching means 54, wherein the latching means 54 is here disposed on the spring means 56. The latching means 54 is adjustable in the direction of or counter to the force of the spring means 56.

The present FIG. 1 shows the locking device 5 in the basic position G, so that the electric machine tool is in “drilling operation” or “hammer drilling operation”.

By means of the locking device 5, the mechanical actuating device 9 can be locked in a switch-on position E. Embodiments in which the mechanical actuating device 9 is locked in another position by means of the locking device 5 are also conceivable, however.

The mechanical actuating device 9 is configured as a rocker switch. Below, the terms mechanical actuating device 9 and rocker switch are used synonymously. The rocker switch 9 here has a first rocker switch part 91, for adjustment into the switch-on position E, and a second rocker switch part 92, for resetting into the switch-off position A. The rocker switch 9 is mounted in the handle casing 3 rotatably about a rocker switch pivot point 93. The first and second rocker switch parts 91, 92 are respectively adjustable by pressing by the operator of the electric machine tool 1, wherein the rocker switch 9 is rotated in or counter to a rocker switch rotational direction (here shown by an arrow 99).

The rocker switch 9 further has a counterlatching means 94. When the rocker switch 9 is locked by means of the locking device 5, the counterlatching means 94 of the rocker switch 9 cooperates with the latching means 54 of the locking device 5. The counterlatching means 94 is here configured as a locking roller. Below, the terms counterlatching means 94 and locking roller are used synonymously.

When the operating mode switch 41 is adjusted from “drilling operation” or from “hammer drilling operation” into “chipping operation”, the slide bar 42 is displaced by means of the cam contour of the operating mode switch 41 in the displacement direction 43. As a result, the slide bar 42 pulls on the first connecting means 6, so that the pivot means 55 of the locking device 5 is rotated out of its basic position G by means of the tilt lever part 51 against the resetting force 52, in the locking rotational direction 59, into the locking position AR.

When the first rocker switch part 91 is pressed, the rocker switch 9 is rotated in the rocker switch rotational direction 99 into the switch-on position E. The rocker switch rotational direction 99 is directed counter to the locking rotational direction 59, so that the latching means 54 of the locking device 5 and the counterlatching means 94 of the rocker switch 9, when the first rocker switch part 91 is pressed or if the first rocker switch part 91 is already pressed, enter into mutual engagement when the pivot means 55 of the locking device 5 is rotated into the locking position AR or if it is already in the locking position AR.

In the embodiment shown in FIG. 1, the latching means 54 rolls down the locking roller 94, whereupon it is dislodged, that is to say it is initially adjusted against the force of the spring means 56 and then reset, to be precise axially displaced. As a result, it latches onto the locking roller 94, so that the spring force of the spring means 56 holds the rocker switch 9 in the switch-on position E.

Through pressing of the second rocker switch part 92, the rocker switch 9 is rotated against the rocker switch rotational direction 99. The latching means 54 is hereupon dislodged, so that the rocker switch 9 is reset from the switch-on position E into the switch-off position A and is no longer locked by means of the locking device 5.

When the operating mode switch 41 is reset from “chipping operation” into “drilling operation” or into “hammer drilling operation”, the slide bar 42 is displaced against the sliding direction 43, so that the locking device 5 is reset from the locking position AR into the basic position G. The locking device 5 is hereupon drawn back by means of the adjusting force 52 into the basic position G, whereupon the first connecting means 6 is subjected to tensile load. The first connecting means 6 is here configured as a band which is capable of withstanding only tensile load and which is supported on the leaf spring 10. It is made, for instance, of a plastic.

The rocker switch 9 is connected by means of a second connecting means 7 to an electric switch 8. The second connecting means 7 is here configured as a Bowden cable and has a first end 71 and a second end 72. The Bowden cable 7 comprises a cable 73 and a sheath 74, wherein the sheath 74 is mounted, for the absorption of compressive forces, at the first end and at the second end 71, 72, respectively in receiving fixtures. The cable 73 is connected at the first end 71 to the rocker switch 9 and at the second end 72 to a sliding means 81 of the electric switch 8. It is also preferred to configure the second connecting means 7 as a band.

Through pressing of the first rocker switch part 91, the rocker switch 9 is displaced into the switch-on position E. The sliding means 81 of the electric switch 8 is hereupon pulled by means of the second connecting means 7 in a displacement direction (here shown by an arrow 82), so that the electric switch 8 is adjusted into the switched-on position. In the switched-on position of the switch 8, the electric machine tool 1 is driven.

Through pressing of the second rocker switch part 91, the rocker switch 9 is displaced into the switch-off position A. The sliding means 81 of the electric switch 8 is hereupon pulled by means of the second connecting means 7 against the displacement direction 82, so that the electric switch 8 is adjusted into the switched-off position. In the switched-off position of the switch 8, the electric machine tool 1 is not driven.

In order to facilitate the operation of the rocker switch 9, the second connecting means 7 is connected to the sliding means 81 by means of a transforming means 78, which is here configured as a cable control. Within the scope of the embodiment of FIG. 1, the terms transforming means 78 and cable control are used synonymously. When the rocker switch 9 is pressed, the cable control 78 brings about a reduction of the force necessary to adjust the sliding means 81.

The handle casing 3 has a grip region 31, which extends along a longitudinal extent 95 of the mechanical actuating device 9. The grip region 31 is therefore that region of the handle casing 3 in which the mechanical actuating device 9 is disposed. It is of sleeve-shaped configuration and has an interior 311, as well as an outer face 312, which is formed by a part of the handle casing 3 and by the mechanical actuating device 9. The mechanical actuating device extends into the interior of the grip region and in the interior of the grip region is disposed the locking device.

According to the invention, the electric switch is disposed outside of the grip region.

FIG. 2 shows a section A-A through the electric machine tool 1 of FIG. 1. The section A-A is placed in the tool housing 2 of the electric machine tool 1.

The first connecting means 6, which is configured as a band and the first end 61 of which is fixed to the slide bar (see FIG. 1), and the second connecting means 7, which is configured as a Bowden cable and the first end 71 of which is connected by the cable control 78 to the sliding means 81 of the electric switch 8, are visible.

The switch 8 is disposed in the tool housing 2 of the electric machine tool 1 and extends along a switch longitudinal extent 85, which runs roughly parallel to the longitudinal extent 95 of the rocker switch 9.

FIG. 3 shows the mechanical actuating device 9, the locking means 5, the electric switch 8 and the first and second connecting means 6, 7 of the electric machine tool 1 of FIG. 1.

In the representation, it is apparent that the pivot means 55 is supported with a restoring spring 58, here configured as a compression spring, on the rocker switch 9. When the locking device 5 is rotated in the locking rotational direction 59, the pivot means 55 is therefore rotated against the resetting force 52 of this restoring spring 58.

The combination of the at least partially flexibly configured first and second connecting means 6, 7 enables an almost optional arrangement of the electric switch 8 in the electric machine tool 1 and outside of the grip region 31.

FIG. 4 shows the electric machine tool 1 of FIG. 1 with a section through the locking device 5. The spring means 56 is hence visible. FIG. 4 shows the rocker switch 9 in the switch-on position E and the locking device 5 in the locking position AR, so that the latching means 54 is latched on the locking roller 94 and the locking means 5 locks the rocker switch 9 in the switch-on position E.

The spring means 56 is disposed in the pivot means 55. In addition, the latching means 54 is also disposed at least partially in the pivot means 55 and bears against the spring means 56. As a result, the latching means 54 is axially displaceable in the direction of or counter to the force of the spring means 56 in the pivot means 55. The latching means 54 is mounted and held in the pivot means 55 by means of a bayonet fastening, for instance.

When the second rocker switch part 92 is pressed, the locking roller 94 is pushed over the latching means 54 and the latching means 54 is hereupon dislodged. The rocker switch 9 is thereby rotated from the switch-on position E into the switch-off position A.

FIG. 5 shows a detail from a further embodiment of an inventive electric machine tool 1. The electric machine tool 1 of FIG. 5 differs from the electric machine tool 1 of FIG. 1 by the arrangement of the electric switch 8 at least partially in the handle casing 3, but outside of the grip region 31 of the handle casing 3. The electric switch 8 extends at least partially into a bellows element 21.

In addition, the rocker switch 9 of this electric machine tool 1 has a lever 97, with which the electric switch 8 can be actuated. The lever 97 is here configured as a push rod, which is attached in a rotationally resilient manner. It converts the rotary motion of the rocker switch 9 into a roughly rectilinearly running sliding motion at the electric switch 8. The lever 97 is here produced in one piece with the rocker switch 9 and is connected thereto by means of a film hinge 98.

Moreover, the switch longitudinal extent 85 of the electric switch 8 of this inventive electric machine tool 1 is disposed roughly at a right angle α to the longitudinal extent 95 of the rocker switch 9.

FIG. 6 and FIG. 7 respectively show a mechanical actuating device 9 and a locking device 5 for an inventive electric machine tool 1, to be precise respectively in (a) in a switch-off position A and in (b) in a switch-on position E of the mechanical actuating device 9.

In the embodiment of FIG. 6, the spring means 56 is disposed on the pivot means 55 and bent, so that it has a resetting arm 58′ for generating the resetting force 52 for resetting the locking device 5 from the locking position AR into the basic position G. In addition, the spring means 56 has a latching arm 54′ having a bend 54″ provided as latching means, wherein the bend 54″, for the locking of the rocker switch 9, cooperates with the locking roller 94 of the rocker switch 9. Moreover, the tilt lever part 51 is disposed on the pivot means 55. Furthermore, the pivot means 55 is mounted rotatably about the locking pivot point 53. When being dislodged, the latching means 54″ is therefore rotated about the locking pivot point 53.

The locking device 5 of FIG. 7 has a pivot means 55, which is rotatable about the pivot point 53 and is held by means of a restoring spring 58, here configured as a torsion spring 58, in the basic setting G. Both the tilt lever part 51 and the latching means 54 are disposed on the pivot means 55, and are preferably formed in one piece therewith. Although the latching means 54 of this locking device 5 is rotatable about the pivot point 53, it is not resiliently adjustable in the direction of or counter to the force of a spring means, since this locking device has no such spring means.

Instead, the locking roller 94 of the rocker switch 9 (not shown here)—in contrast to the previously presented rocker switches 9—is disposed on a rocker 941, which is mounted rotatably about a fulcrum 943 disposed in the rocker switch 9. The rocker is supported on the rocker switch 9 by means of a spring means 946, here configured as a compression spring. The locking roller 94 is hence mounted rotatably about the fulcrum 943. In this embodiment, the locking roller 94 is therefore dislodgeable.

FIG. 8 shows a detail from a further embodiment of an inventive electric machine tool 1. FIG. 8 shows the connection of the second connecting means 7 to the sliding means 81 of the electric switch 8. In actual fact, a lever gear mechanism is here provided as a transforming means 78.

In FIG. 8, the rocker switch 9, rotatable about the rocker switch pivot point 93, and the second connecting means 7 are represented. When the first pawl part 91 is pressed, the pawl 9 is adjusted by the length of an adjustment path 96. The adjustment path 96 is here shown, by way of example, by the adjustment path 96 by whose length the second end 72 of the second connecting means 7 is here displaced. The lever gear mechanism 78 is thereby adjusted, so that the sliding means 81 of the electric switch 8 is here displaced by the length of a slide path 86.

The lever gear mechanism here enables a reduction of the force to be applied to the rocker switch 9 for the adjustment of the sliding means 81. In addition, the lever gear mechanism 78 enables the realization of a nonlinear course of adjusting force to adjustment path 96.

1. An electric machine tool comprising:
a handle casing including:
a mechanical actuating device;
a locking device configured to lock the mechanical actuating device in at least one operating state of the electric machine tool;
an electric switch configured to be adjusted by the mechanical actuating device into a switched-on position and a switched-off position; and
a grip region extending along a longitudinal extent of the mechanical actuating device,
wherein the electric switch is disposed outside of the grip region.

2. The electric machine tool as claimed in claim 1, wherein the electric switch extends along a switch longitudinal extent which is provided at an angle to the longitudinal extent of the actuating device.

3. The electric machine tool as claimed in claim 1, further comprising:
a tool housing on which the handle casing is disposed such that the handle casing is movable relative to the tool housing, wherein the electric switch is disposed in the tool housing.

4. The electric machine tool as claimed in claim 1, wherein the locking device is disposed within the grip region.

5. The electric machine tool as claimed in claim 1, further comprising:
an operating mode switch; and
an at least partially flexible first connecting mechanism configured to connect the locking device to the operating mode switch.

6. The electric machine tool as claimed in claim 1, wherein the locking device is rotatably mounted on the handle casing.

7. The electric machine tool as claimed in claim 5, further comprising:
an at least partially flexible second connecting mechanism configured to connect the mechanical actuating device to the electric switch.

8. The electric machine tool as claimed in claim 7, further comprising:
a transforming mechanism disposed on the second connecting mechanism.

9. The electric machine tool as claimed in claim 1, wherein the mechanical actuating device is a rocker switch, which is rotatably mounted on the handle casing.

10. The electric machine tool as claimed in claim 9, wherein:
the rocker switch has a first rocker switch part and a second rocker switch part, and
the rocker switch is adjustable by actuation of the first rocker switch part into a switch-on position, and by actuation of the second rocker switch part into a switch-off position.

11. The electric machine tool as claimed in claim 7, wherein at least one of the first connecting mechanism and the second connecting mechanism is configured to do one of:
withstand only tensile load, and
withstand both tensile and compressive load.

12. A handle casing for an electric machine tool comprising:
a mechanical actuating device;
a locking device configured to lock the mechanical actuating device in at least one operating state of the electric machine tool;
an electric switch configured to be adjusted by the mechanical actuating device into a switched-on position and a switched-off position; and
a grip region extending along a longitudinal extent of the mechanical actuating device,
wherein the electric switch is disposed outside of the grip region.

13. The handle casing as claimed in claim 12, wherein the locking device is disposed within the grip region.

14. The handle casing as claimed in claim 12, wherein the mechanical actuating device is a rocker switch which is rotatably mounted on the handle casing.

15. A connecting mechanism for an electric machine tool comprising:
a first end connected to a sliding mechanism of an electric switch;
a second end connected to a mechanical actuating device; and
a transforming mechanism,
wherein the connecting mechanism is configured such that a force applied to adjust the mechanical actuating device by a length of an adjustment path adjusts the sliding mechanism by a slide path,
wherein the transforming mechanism is configured to do at least one of:
vary the force is variable along the adjustment path, and
reduce the force,
wherein the connecting mechanism is at least partially flexible.
